(19) United States
(12) Patent Application Publication
(10) Pub. No.: US 2025/0091272 A1
(43) Pub. Date: Mar. 20, 2025

(54) INJECTION MOLDING SYSTEM

(71) Applicant: SEIKO EPSON CORPORATION, Tokyo (JP)

(72) Inventors: Seijun HORIE, Matsumoto-shi (JP); Kazunobu MARUYAMA, Shiojiri-shi (JP); Kai UCHIYAMA, Matsumoto-shi (JP); Hiroki TAKANO, Matsumoto-shi (JP)

(21) Appl. No.: 18/883,372

(22) Filed: Sep. 12, 2024

(30) Foreign Application Priority Data
Sep. 15, 2023 (JP) 2023-150005

(51) Int. Cl. B29C 45/76; B29C 45/04; B29C 45/17; B29C 45/42; B29K 105/00; B29K 105/16; B29K 505/00

(52) U.S. Cl. CPC B29C 45/762; B29C 45/0408; B29C 45/1753; B29C 45/1769; B29C 45/42; B29K 2105/16; B29K 2105/251; B29K 2505/00

(57) ABSTRACT

An injection molding system including an injection molding device including an injection molding section that has a fixed section to which a fixed molding die and a movable molding die are attached and fixed and that is configured to mold a molded article by injecting a material containing a metal powder into a cavity, and a first movement section for moving the movable molding die between a molding die closed position and a molding die open position, a cleaning device that performs cleaning of the molded article by blowing air, and a control device, wherein when the movable molding die is not at the molding die closed position, the control device does not cause the cleaning device to blow air, and when the movable molding die is at the molding die closed position, the control device causes the cleaning device to perfom blowing of air.

The present application is based on, and claims priority from JP Application Serial Number 2023-150005, filed Sep. 15, 2023, the disclosure of which is hereby incorporated by reference herein in its entirety.

### BACKGROUND

### 1. Technical Field

This disclosure relates to injection molding systems.

### 2. Related Art

Research and development have been carried out on technology for injection molding of molded articles.

In this regard, an injection molding system is known that automatically performs an injection molding step of injection molding a molded article and a step performed after the injection molding step in this order (see JP-A-2016-525712).

An injection molding system such as described in JP-A-2016-525712 is also applicable to the molding of molded articles by injection molding using materials containing metallic powders. In this case, the injection molding system performs, as the step performed after the injection molding step, a sintering step of sintering the molded article after injection molding. Therefore, in this case the ejection molding system could not perform a cleaning step of cleaning the molded article while immersing the molded article in an alkaline aqueous solution because it would cause a decrease in the molding accuracy of the molded article. However, if a cleaning step is not performed in the injection molding system, foreign matter may adhere to the molded article before the sintering step. This leads to a decrease in the forming accuracy of the molded article, which is not desirable.

### SUMMARY

To solve the aforementioned issue, an injection molding system of one aspect of the present disclosure includes an injection molding device including a fixed section to which a fixed molding die and a movable molding die, which faces the fixed molding die and which is reciprocable with respect to the fixed molding die, are attached and fixed, an injection molding section configured to mold a molded article by injecting a material containing a metal powder into a cavity formed between the fixed molding die and the movable molding die, and a first movement section for moving the movable molding die between a molding die closed position and a molding die open position; a cleaning device configured to clean a molded article that was taken out from the injection molding device by blowing air onto the molded article; and a control device configured to control the injection molding device and the cleaning device, wherein the control device, when the fixed molding die and the movable molding die are attached to the fixed section and the movable molding die is not located at the molding die closed position, does not cause the cleaning device to blow out air and, when the fixed molding die and the movable molding die are attached to the fixed section and the movable molding die is located at the molding die closed position, causes the cleaning device to blow out air.

### BRIEF DESCRIPTION OF THE DRAWINGS

FIG. 1 is a perspective view showing an example of configuration of an injection molding system 1.

FIG. 2 is a top view of the injection molding system 1 shown in FIG. 1.

FIG. 3 is a front view showing an example of configuration of a cleaning device 40. The cleaning device 40 has a nozzle 41, a suction port 42, and a suction port 43.

FIG. 4 is a diagram showing an example of configuration of a control device 70.

FIG. 5 is a diagram showing an example of flow of processes for palletizing onto a pallet PT a plurality of molded articles that were molded by an injection molding device 10.

FIG. 6 is a perspective view showing an example of the periphery of the cleaning device 40 in the case where a partition plate BD is provided between the cleaning device 40 and the pallet PT.

### DESCRIPTION OF EMBODIMENTS

Embodiments of the present disclosure will be described below with reference to the drawings.

### Overview of Injection Molding System

First, an overview of the injection molding system according to the embodiment will be described.

An injection molding system according to an embodiment includes an injection molding device, a cleaning device, and a control device. An injection molding device is provided with an injection molding section and a first movement section. The injection molding section includes a fixed section to which are attached and fixed a fixed molding die and a movable molding die, which faces the fixed molding die and which is capable of reciprocating relative to the fixed molding die, and molds a molded article by injecting a material containing metal powder into a cavity formed between the fixed molding die and the movable molding die. The first movement section moves the movable molding die between a molding die closed position and a molding die open position. The cleaning device cleans the molded article by blowing air onto the molded article that was taken out from the injection molding device. The control device controls the injection molding device and the cleaning device. When the fixed molding die and the movable molding die are attached to the fixed section and the movable molding die is not located at the molding die closed position, the control device does not cause the cleaning device to blow out air, and when the fixed molding die and the movable molding die are attached to the fixed section and the movable molding die is located at the molding die closed position, the control device causes the cleaning device to blow out air. By this, the injection molding system can suppress foreign matter from entering between the fixed molding die and the movable molding die due to air blown out from the cleaning device, and can suppress that molding accuracy of the molded article drops due to the adhesion of the foreign matter.

Hereinafter, the configuration of the injection molding system according to the embodiment and the processes of the control device provided in the injection molding system will be described in detail.

### Configuration of Injection Molding System

Hereinafter, configuration of the injection molding system according to the embodiment will be described using an injection molding system 1 as an example.

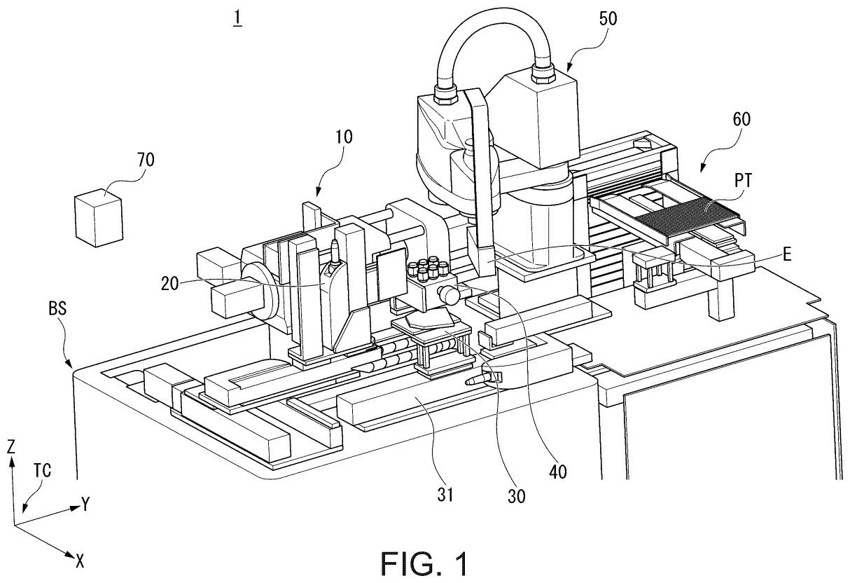

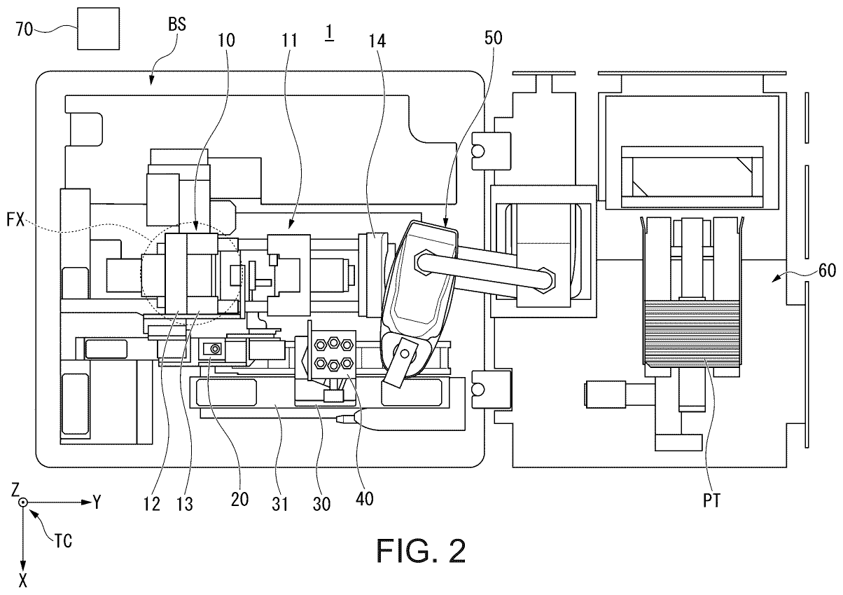

FIG. 1 is a perspective view showing an example of configuration of an injection molding system 1. FIG. 2 is a top view of the injection molding system 1 shown in FIG. 1. However, in FIG. 1 and FIG. 2, a part of the housing of the injection molding system 1 is omitted in order to clearly show the configuration of the injection molding system 1. The part of the housing is, for example, a cover or the like constituting at least a part of the outer surface of the injection molding system 1.

Here, the three dimensional coordinate system TC is a three dimensional orthogonal coordinate system indicating directions in the drawing in which the three dimensional coordinate system TC is drawn. Hereinafter, for convenience of description, the X axis in the three dimensional coordinate system TC will be simply referred to as the X axis. Hereinafter, for convenience of description, the Y axis in the three dimensional coordinate system TC is simply referred to as the Y axis. Hereinafter, for convenience of description, the Z axis in the three dimensional coordinate system TC is simply referred to as the Z axis. As an example, a case where the negative direction of the Z axis coincides with the gravity direction will be described below. Therefore, hereinafter, for convenience of description, the positive direction of the Z axis will be referred to as upward or simply as up, and the negative direction of the Z axis will be referred to as downward or simply as down.

The injection molding system 1 is an apparatus for molding a plurality of molded articles by metal powder injection molding (Metal Injection Molding or MIM). More specifically, the injection molding system 1 is an apparatus for automatically performing various processes internally, such as a molding process of molding a molded article by MIM, a cleaning process after the molding process, a palletizing process after the cleaning process, and a sintering process after the palletizing process.

Here, the metal powder used in MIM is, for example, a powder such as an amorphous alloy, but is not limited thereto. Examples of the amorphous alloys include, but are not limited to, Fe—Si—B alloys, which are high strength materials, Fe—Cr—P—C alloys, which are high corrosion resistance materials, and Fe—Si—B compounds, which are magnetic materials.

The injection molding system 1 includes, for example, an injection molding device 10, a first robot 20, an arrangement mechanism 30, a cleaning device 40, a second robot 50, a sintering device 60, and a control device 70. The injection molding system 1 may be configured to include other devices in addition to the injection molding device 10, the first robot 20, the arrangement mechanism 30, the cleaning device 40, the second robot 50, the sintering device 60, and the control device 70. The injection molding system 1 may be configured not to include the first robot 20. In this case, for example, another apparatus having the function of the first robot 20 is connected externally to the injection molding system 1. The injection molding system 1 may be configured not to include the arrangement mechanism 30. In this case, for example, another apparatus having the function of the arrangement mechanism 30 is connected externally to the injection molding system 1. The injection molding system 1 may be configured not to include the second robot 50. In this case, for example, another apparatus having the function of the second robot 50 is connected externally to the injection molding system 1. The injection molding system 1 may configured to not include the sintering device 60. In this case, for example, another apparatus having the function of the sintering device 60 is connected externally to the injection molding system 1.

The injection molding device 10 may have any configuration as long as it can mold one or more molded articles by MIM. Hereinafter, as an example, a case where the injection molding device 10 molds a plurality of molded articles by MIM will be described. In this case, as shown in FIG. 1 and FIG. 2, the injection molding device 10 includes an injection molding section 11 for molding a plurality of molded articles by MIM.

The injection molding section 11 has, for example, a material supply nozzle (not shown) and a fixed section FX. The fixed section FX is a member to which are attached a fixed molding die 12, which is connected to the material supply nozzle, and a movable molding die 13, which is engaged with the fixed molding die 12, and which fixes molding die 12 and the movable molding die 13. That is, in the injection molding section 11 of this example, the fixed molding die 12 and the movable molding die 13 are interchangeable. Here, the material supply nozzle supplies material from the supply device, which supplies material in which metal powder and wax are mixed together, into the space that was formed between the fixed molding die 12 and the movable molding die 13 by engaging the fixed molding die 12 and the movable molding die 13 together. The space may be referred to as a cavity. The injection molding system 1 may be configured to include the supply device or may be configured to not include the supply device. The injection molding section 11 may include at least one of a fixed molding die 12 and a movable molding die 13.

The fixed molding die 12 is a molding die fixed so as not to move with respect to the frame BS of the injection molding device 10. The configuration of the fixed molding die 12 may be a known configuration or a configuration to be developed. Therefore, in the present embodiment, a detailed description of the fixed molding die 12 is omitted. The frame BS may have any structure as long as it constitutes a part of the housing of the injection molding system 1. In the example shown in FIG. 1 and FIG. 2, the injection molding device 10, the first robot 20, and the arrangement mechanism 30 are provided on the frame BS. In the above example, the second robot 50 and the sintering device 60 are both provided on another frame (not shown) arranged adjacent to the frame BS.

The movable molding die 13 is a movable molding die that moves relative to the fixed molding die 12. In other words, the movable molding die 13 is a molding die which faces the fixed molding die 12 and is capable of reciprocating with respect to the fixed molding die 12. The structure of the movable molding die 13 may be a known structure or a structure to be developed later. Therefore, in the present embodiment, a detailed description of the movable molding die 13 is omitted. Hereinafter, as an example, a case will be described wherein the movable molding die 13 is configured to be movable between a first position, which is predetermined as a position where the movable molding die 13 is engaged with the fixed molding die 12, and a second position, which is predetermined as a position separated from the fixed molding die 12. In the example shown in FIG. 1 and FIG. 2, the movable molding die 13 moves relative to the fixed molding die 12 parallel to the Y axis. The movable molding die 13 may be configured to move in a direction not parallel to the Y axis with respect to the fixed molding die 12. The first position is an example of a molding die closed position. The second position is an example of a one side open position. In the following, for convenience of explanation, the state in which the movable molding die 13 is positioned at the molding die closed position will be explained assuming that the fixed molding die 12 and the movable molding die 13 are engaged with each other. Hereinafter, for convenience of description, the state in which the movable molding die 13 is not located at the molding die closed position will be described by assuming that the fixed molding die 12 and the movable molding die 13 are not engaged with each other. As an example, a case where the fixed molding die 12 and the movable molding die 13 are attached to the fixed section FX will be described below.

The injection molding device 10 further includes a first movement section 14.

The first movement section 14 may be any device as long as it is a device for relatively moving the movable molding die 13 between the first position and the second position. In accordance with the control device 70, the first movement section 14 moves the movable molding die 13 in parallel with the Y axis to approach the fixed molding die 12 and moves the movable molding die 13 from the second position to the first position. By this, the movable molding die 13 engages with the fixed molding die 12. On the other hand, in the above example, in accordance with the control from the control device 70, the first movement section 14 moves the movable molding die 13 in parallel with the Y axis away from the fixed molding die 12 and separates the fixed molding die 12 and the movable molding die 13 from each other. That is, in the above example, in accordance with the control from the control device 70, the first movement section 14 moves the movable molding die 13 in parallel with the Y axis away from the fixed molding die 12 and moves the movable molding die 13 from the first position to the second position.

The injection molding device 10 molds a plurality of molded articles in one injection step using the fixed molding die 12 and the movable molding die 13. In this way, the method by which the injection molding device 10 molds a plurality of molded articles using the fixed molding die 12 and the movable molding die 13 may be a known method or a method to be developed. Therefore, in the present embodiment, a detailed description of the method is omitted.

The first robot 20 is a robot that delivers to the arrangement mechanism 30 a plurality of molded articles molded by the injection molding device 10. The first robot 20 holds the plurality of molded articles, for example, by suction with air, and places each of the held plurality of molded articles at a predetermined placement position. By this, the first robot 20 delivers the plurality of molded articles to the arrangement mechanism 30. The placement position is a predetermined position at which the plurality of molded articles are placed on the arrangement mechanism 30. The configuration of the first robot 20 may be any configuration as long as it is a configuration capable of placing each of the plurality of molded articles at a placement position.

The arrangement mechanism 30 is a mechanism that receives a plurality of molded articles from the first robot 20 and that delivers the plurality of received molded articles to the second robot 50.

The housing of the arrangement mechanism 30 is movable between a predetermined first delivery position and a predetermined second delivery position. The first delivery position is a position predetermined as a position that, among the positions where the housing of the arrangement mechanism 30 is movable, is where the plurality of molded articles are received from the first robot 20. The second delivery position is a position determined in advance as a position that, among the positions where the housing of the arrangement mechanism 30 is movable, is where a plurality of molded articles are held by the second robot 50. In the example shown in FIG. 1 and FIG. 2, the housing of the arrangement mechanism 30 is movable parallel to the Y axis. The housing of the arrangement mechanism 30 may be movable in a direction not parallel to the Y axis.

Here, the arrangement mechanism 30 includes a second movement section 31. The second movement section 31 may have any configuration as long as it can move the housing of the arrangement mechanism 30 between the first delivery position and the second delivery position.

The arrangement mechanism 30 may be configured to change the arrangement of a plurality of molded articles that were placed. In this case, the arrangement mechanism 30 is provided with a base, an actuator, and the like as members for changing the arrangement of the plurality of placed molded articles. The members provided in the arrangement mechanism 30 may have any structure as long as the arrangement of a plurality of placed molded articles can be changed. When the arrangement mechanism 30 is provided with the aforementioned members, the arrangement mechanism 30 changes the arrangement of the plurality of placed molded articles at a timing before the delivery of the plurality of molded articles to the second robot 50 at the second delivery position. By this, the arrangement mechanism 30 can arrange the plurality of molded articles in a desired arrangement.

In accordance with the control from the control device 70, the cleaning device 40 cleans the plurality of molded articles taken out from the injection molding device 10 by blowing air at the molded articles. More specifically, the cleaning device 40 blows air to, for example, a plurality of molded articles placed on the arrangement mechanism 30. By this, the cleaning device 40 cleans the plurality of molded articles placed on the arrangement mechanism 30.

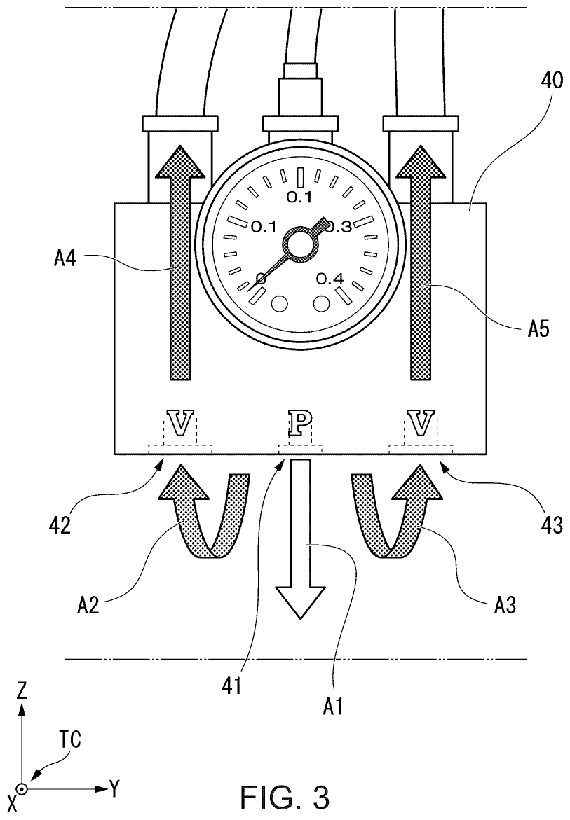

FIG. 3 is a front view showing an example of configuration of a cleaning device 40. The cleaning device 40 has a nozzle 41, a suction port 42, and a suction port 43.

The nozzle 41 is a hole through which the cleaning device 40 blows out air. In the cleaning device 40, the air blown out from nozzle 41 is discharged from nozzle 41 toward the direction in which nozzle 41 extends. The direction indicated by the arrow A1 shown in FIG. 3 indicates an example of the direction in which the air is discharged from nozzle 41.

The suction port 42 and the suction port 43 are holes through which the cleaning device 40 sucks air. That is, the cleaning device 40 sucks air through the suction port 42 and the suction port 43. Each of the suction port 42 and the suction port 43 is provided around nozzle 41. This is for sucking, together with the air, the foreign matter that was blown off from the plurality of molded articles by the air blown out from nozzle 41. In the example shown in FIG. 3, the suction port 42 and the suction port 43 are provided on either side of nozzle 41. More specifically, in the above example, the nozzle 41, the suction port 42, and the suction port 43 are arranged in the order of the suction port 42, the nozzle 41, and the suction port 43 toward the positive direction of the Y axis. An arrow A2 shown in FIG. 3 indicates an example of a state in which a part of the air discharged from nozzle 41 is being sucked through the suction port 42. An arrow A3 shown in FIG. 3 indicates an example of a state in which a part of the air discharged from nozzle 41 is being sucked through the suction port 43. An arrow A4 shown in FIG. 3 indicates a direction in which the air is sucked through the suction port 42. An arrow A5 shown in FIG. 3 indicates a direction in which air is sucked through the suction port 43.

The cleaning device 40 may be provided at any position as long as it is a position that enables air to be blown from the nozzle 41 to the plurality of molded articles placed on the arrangement mechanism 30. In the example shown in FIG. 3, the cleaning device 40 is provided above the path through which the arrangement mechanism 30 passes when moved, so as not to interfere with the moving arrangement mechanism 30. The cleaning device 40 is provided above the path such that the direction in which the air is discharged from nozzle 41 faces downward. Therefore, in FIG. 3, an arrow A1 indicating a direction in which the cleaning device 40 blows out the air indicates a downward direction. When the molded articles placed on the arrangement mechanism 30 pass under the cleaning device 40, the air blown from the cleaning device 40 blows over the molded articles. As a result, the cleaning device 40 can use the air to blow off the foreign matter clinging to each of the plurality of molded articles placed on the arrangement mechanism 30 that is moving in parallel with the Y axis. Here, in the cleaning device 40, the smaller the size of each of the plurality of molded articles before sintering or the more fragile the plurality of molded articles before sintering, the smaller that the wind pressure of the blowing air should be. This is to reduce the possibility that the molded article itself is blown off by the air and the possibility that the shape of the molded article is deformed by the air. However, the smaller the wind pressure of the air blown at the plurality of molded articles, the more difficult it is for the air blown from the cleaning device 40 to blow off the foreign matter clinging to each of the plurality of molded articles. In order to overcome such a problem, the cleaning device 40 may be configured to blow ultrasonic vibration air, for example, as the air to be blown at the plurality of molded articles. In this case, the cleaning device 40 can make it easier to blow off the foreign matter clinging to each of the plurality of molded articles while reducing the wind pressure of the air blown at the plurality of molded articles. The cleaning device 40 sucks the foreign matter that was blown off by the air through the suction port 42 and the suction port 43. By this, the cleaning device 40 can prevent the foreign matter blown that was off by the air from adhering to the molded article again.

Hereinafter, for convenience of description, a region in which air is discharged from nozzle 41 of the cleaning device 40 will be referred to as a cleaning region. That is, the cleaning region is a region including a part of a path through which the arrangement mechanism 30 passes when moving.

The second robot 50 may have any configuration as long as a plurality of molded articles after being cleaned by the cleaning device 40 can be placed from the arrangement mechanism 30 onto the pallet PT stored in the sintering device 60.

The second robot 50 is, for example, a scalar robot. Instead of a scalar robot, the second robot 50 may be a single-arm multi-joint robot, a double-arm multi-joint robot, or another type of robot.

The second robot 50 is provided with a support base (not shown) for supporting the entire second robot 50, a first arm rotatably supported by the support base, a second arm rotatably supported by the first arm, a shaft penetrating through the tip of the second arm in parallel with the direction of gravity, and an end effector E provided at the tip of the shaft.

The end effector E may have any configuration as long as it can hold a plurality of molded articles placed on the arrangement mechanism 30 and place the held plurality of molded articles onto the pallet PT located in the sintering device 60. The end effector E holds the plurality of molded articles, for example, by suction of air. The end effector E may be provided with a clamping section for clamping each of the plurality of molded articles.

Here, the pallet PT in the sintering device 60 is heated in the sintering device 60 together with the plurality of placed molded articles. Therefore, the pallet PT is made of, for example, ceramic. The pallet PT may have any configuration as long as a plurality of molded articles cleaned by the cleaning device 40 can be placed on it and also it can be heated in the sintering device 60 together with the placed plurality of molded articles. However, in the case where the pallet PT is made of ceramic as in this example, the simpler the structure is, the lower the cost becomes, which is desirable.

The end effector E of the second robot 50 may be configured to change the arrangement of the plurality of molded articles after cleaning by the cleaning device 40 is performed and to place the plurality of molded articles after the arrangement of the plurality of molded articles had been changed onto the pallet PT. In this case, however, the arrangement mechanism 30 is not provided with a member for changing the arrangement of the plurality of placed molded articles. That is, in this case, the arrangement mechanism 30 does not change the arrangement of the plurality of placed molded articles. In this case, the end effector E of the second robot 50 is provided with a base, an actuator, and the like as members for changing the arrangement of the plurality of placed molded articles. By this, the second robot 50 can arrange the plurality of molded articles to be placed on the pallet PT in a desired arrangement, and as a result, the number of the plurality of molded articles to be placed on the pallet PT can be increased.

When the arrangement mechanism 30 is provided with a member for changing the arrangement of the plurality of placed molded articles, the end effector E of the second robot 50 may be a configuration provided with a member for changing the interval between the molded articles after the arrangement is changed in the arrangement mechanism 30. In this case, the second robot 50 places on the pallet PT the plurality of molded articles after the interval was changed by the end effector E. As a result, the second robot 50 can increase the number of the molded articles to be inserted into the pallet PT.

The sintering device 60 is an apparatus in which the pallet PT is located as well as in the second robot 50, and a plurality of molded articles that were placed on the pallet PT by the second robot 50 are heated together with the pallet PT to sinter the plurality of molded articles. The sintering device 60 may be configured to include a device for automatically storing the palletized pallet PT and automatically supplying a new pallet PT, or may be configured so that the pallet PT is replaced manually.

The control device 70 controls the entire injection molding system 1. In FIG. 1, in order to simplify the drawing, the manner in which the control device 70 is connected to other devices included in the injection molding system 1 is omitted. The control device 70 may be located at any position in the injection molding system 1. The control device 70 may be configured separately from any of the other devices. The control device 70 may be integrated with some or all of the other devices.

The control device 70 is, for example, a workstation, a desktop personal computer (PC), a notebook PC, or the like, but is not limited these.

The control device 70 controls the injection molding device 10 to mold a plurality of molded articles. After a plurality of molded articles are molded by the injection molding device 10, the control device 70 controls the injection molding section 11 and separates the movable molding die 13 from the fixed molding die 12. After the movable molding die 13 is separated from the fixed molding die 12, the control device 70 controls the first robot 20 and causes the first robot 20 to take the plurality of molded articles molded by the injection molding device 10 out from the injection molding device 10. After the plurality of molded articles are taken out from the injection molding device 10 by the first robot 20, the control device 70 controls the first robot 20 and causes the first robot 20 to place the plurality of molded articles that were taken out from the injection molding device 10 onto the arrangement mechanism 30. After the plurality of molded articles are placed on the arrangement mechanism 30, the control device 70 controls the injection molding section 11 to engage the movable molding die 13 with the fixed molding die 12. After the movable molding die 13 is engaged with the fixed molding die 12, the control device 70 controls the cleaning device 40 and causes the cleaning device 40 to blow air toward the cleaning region. The control device 70 starts to cause the cleaning device 40 to blow air together with starting molding of a new plurality of molded articles by the injection molding section 11. After the cleaning device 40 blows air, the control device 70 controls the arrangement mechanism 30 on which the plurality of molded articles were placed, and causes the arrangement mechanism 30 to repeatedly pass through the cleaning region. Here, the number of times that the control device 70 causes the arrangement mechanism 30 to repeat passing through the cleaning region may be any number as long as it is one or more times. Hereinafter, as an example, a case will be described in which the control device 70 causes the arrangement mechanism 30 to repeatly pass through the cleaning region until a predetermined cleaning end condition is satisfied. The cleaning end condition is, for example, the end of the hold pressure against the molded articles in the space between the fixed molding die 12 and the movable molding die 13, but is not limited thereto. For example, when the control device 70 judges that the hold pressure has ended, the control device 70 controls the cleaning device 40 and stops the cleaning device 40 from blowing air at the cleaning region. After blowing of air has ended, the control device 70 controls the injection molding section 11 to separate the movable molding die 13 from the fixed molding die 12. By this, the control device 70 can cause the first robot 20 to take out the new plurality of molded articles. After the air blowing is completed, the control device 70 controls the arrangement mechanism 30 to move the arrangement mechanism 30 to the second delivery position. After the arrangement mechanism 30 has moved to the second delivery position, the control device 70 controls the second robot 50 to palletize onto the pallet PT the plurality of molded articles that had been placed on the arrangement mechanism 30. After the plurality of molded articles are palletized into the pallet PT, the control device 70 moves the arrangement mechanism 30 to the first delivery position, and causes the first robot 20 to place a new plurality of molded articles onto the arrangement mechanism 30. By repeating the processes from molding to palletizing of molded articles, the control device 70 palletizes a predetermined number of molded articles onto the pallet PT. After the predetermined number of molded articles have been palletized into the pallet PT, the control device 70 controls the sintering device 60 to heat and sinter the aforementioned number of molded articles together with the pallet PT.

Thus, when the fixed molding die 12 and the movable molding die 13 are not engaged together, the control device 70 does not cause the cleaning device 40 to blow out air. In other words, in the above-mentioned case, the control device 70 does not cause the cleaning device 40 to blow air from the cleaning device 40 to the plurality of molded articles. On the other hand, when the fixed molding die 12 and the movable molding die 13 are engaged with each other, the control device 70 causes the cleaning device 40 to blow out air. In other words, in the aforementioned case, the control device 70 causes the cleaning device 40 to blow air from the cleaning device 40 to the plurality of molded articles. By this, the control device 70 can suppress that foreign matter enters between the fixed molding die 12 and the movable molding die 13 due to air being blown out from the cleaning device 40, and can prevent a decrease in molding accuracy of the molded article due to the adhesion of the foreign matter. Here, for example, when the cleaning device 40 blows out ultrasonic vibration air, the control device 70 can remove the foreign matter clinging to the molded articles while reducing the wind pressure of the ultrasonic vibration air blown at the molded articles before sintering. As a result, even if the plurality of molded articles before sintering are small or the plurality of molded articles before sintering are fragile, the control device 70 can remove foreign matter clinging to the plurality of molded articles while suppressing deformation of the plurality of molded articles.

The cleaning device 40 may be provided with a third movement section that moves the cleaning device 40 above the moving path of the arrangement mechanism 30 in parallel with the moving path. In this case, the control device 70 controls at least one of the second movement section 31 and the third movement section and moves the relative positions of the cleaning device 40 and the arrangement mechanism 30 on which the plurality of molded articles that were taken out from the injection molding device 10 are placed. By this, the control device 70 may be configured to repeatly pass the arrangement mechanism 30 through the cleaning region. That is, instead of the configuration in which the control device 70 causes the arrangement mechanism 30 to repeatedly pass through the cleaning region by moving the arrangement mechanism 30 with respect to the cleaning device 40, it may be a configuration wherein the arrangement mechanism 30 is repeatedly passed through the cleaning region by moving the cleaning device 40 with respect to the arrangement mechanism 30, or may be configuration wherein the arrangement mechanism 30 is repeatedly passed through the cleaning region by moving both the arrangement mechanism 30 and the cleaning device 40.

### Configuration of Control Device

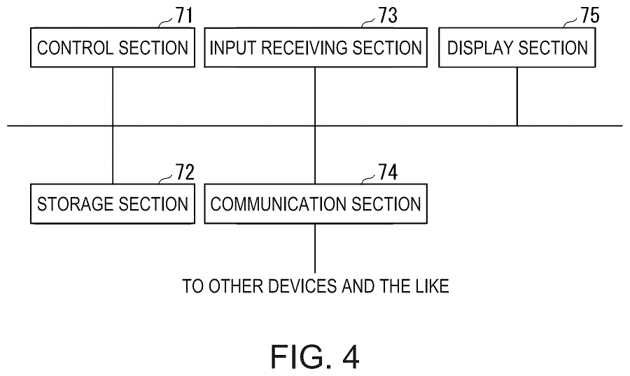

Below, configuration of the control device 70 will be described with reference to FIG. 4. FIG. 4 is a diagram showing an example of configuration of a control device 70.

The control device 70 includes, for example, a control section 71, a storage section 72, an input receiving section 73, a communication section 74, and a display section 75. These components are communicatively connected to each other via a bus. The control device 70 communicates with the injection molding device 10, the first robot 20, the arrangement mechanism 30, the cleaning device 40, the second robot 50, the sintering device 60, and the like via the communication section 74.

The control section 71 includes, for example, a central processing unit (CPU) and a field programmable gate array (FPGA) processor. The control section 71 executes various programs stored in the storage section 72. By this, the control section 71 controls the entire injection molding system 1.

The storage section 72 is a storage device including, for example, a hard disk drive (HDD), a solid state drive (SSD), an electrically erasable programmable read only memory (EEPROM), a read only memory (ROM), a random access memory (RAM), and the like. Instead of being built into the control device 70, the storage section 72 may be an external storage device connected by a digital input/output port such as a universal serial bus (USB). The storage section 72 stores various kinds of information, various kinds of images, and various kinds of programs that are processed by the control device 70.

The input receiving section 73 is an input device including a keyboard, a mouse, a touch pad, and the like. The input receiving section 73 may be formed integrally with the display section 75 as a touch panel.

The communication section 74 is a communication device including, for example, a digital input/output port such as a USB, an Ethernet (registered trademark) port, an antenna for wireless communication, and the like.

The display section 75 is a display device including a liquid crystal display or the like.

Processes for palletizing plural molded articles from injection molding device to pallet.

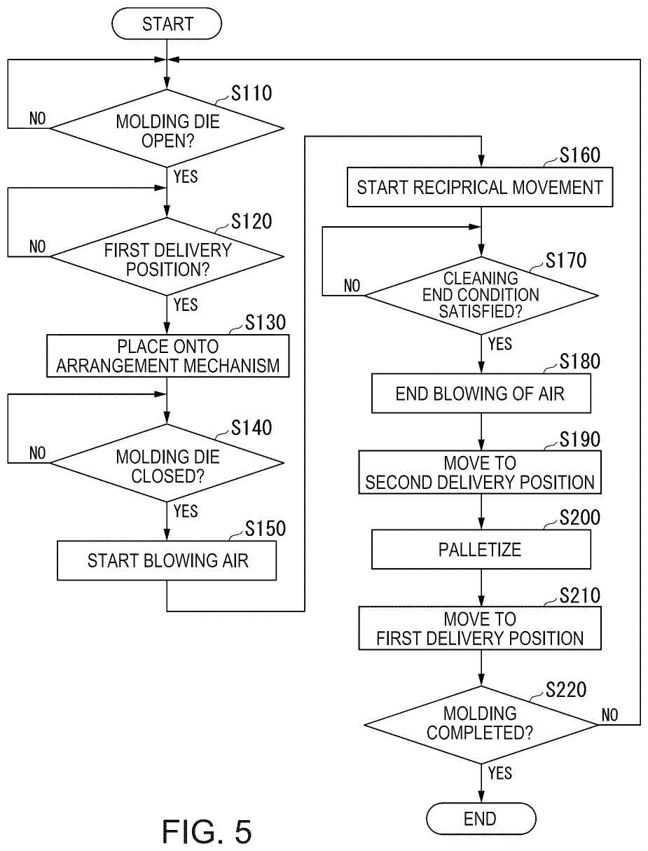

With reference to FIG. 5, among the processes performed by the control device 70, a process for palletizing a plurality of molded articles molded by the injection molding device 10 to the pallet PT will be described below. FIG. 5 is a diagram showing an example of flow of processes for palletizing onto a pallet PT a plurality of molded articles that were molded by an injection molding device 10. When the control device 70 receives, for example, a molding start operation for causing the control device 70 to start a process for causing the injection molding system 1 to repeatedly mold plural molded articles a predetermined number of times, the control device 70 starts a process for causing the injection molding device 10 to repeatedly mold the plural molded articles for the number of times, and starts the processes of the flowchart shown in FIG. 5. However, in the present embodiment, the process of causing the injection molding device 10 to repeatedly mold the plural molded articles for the above-mentioned number of times is a known process, and therefore a description thereof is omitted.

After the start molding operation is received, the control section 71 waits until the molding of the plural molded articles by the injection molding device 10 is completed and the movable molding die 13 is separated from the fixed molding die 12 (Step S110). In FIG. 5, the process in Step S110 is indicated by “molding die open?” The method by which the control section 71 determines whether or not the movable molding die 13 is separated from the fixed molding die 12 may be a known method or a method to be developed.

When the control section 71 determines that the movable molding die 13 is separated from the fixed molding die 12 (YES in Step S110), that is, when the position of the movable molding die 13 is moved to the second position, then the control section 71 determines whether the position of the arrangement mechanism 30 is the first delivery position (Step S120). In FIG. 5, the process of Step S120 is indiated by “first delivery position?” The method for determining whether the position of the arrangement mechanism 30 is the first delivery position may be a known method or a method to be developed.

When the control section 71 determines that the position of the arrangement mechanism 30 is not the first delivery position (NO in Step S120), the control section 71 returns to Step S120, and again determines whether the position of the arrangement mechanism 30 is the first delivery position.

On the other hand, when the control section 71 determines that the position of the arrangement mechanism 30 is the first delivery position (YES in Step S120), the control section 71 controls the first robot 20 to cause the first robot 20 to take the plurality of molded articles molded by the injection molding section 11 out from the injection molding section 11. Then, the control section 71 causes the first robot 20 to place the plurality of molded articles that were taken out by the first robot 20 onto the arrangement mechanism 30 (Step S130). In FIG. 5, the process of Step S130 is indicated by “place onto arrangement mechanism.”

Next, the control section 71 waits until the movable molding die 13 is engaged with the fixed molding die 12 in order to mold the next pluralality of molded articles in the process of causing the injection molding device 10 to repeatedly mold plural molded articles a predetermined number of times (Step S140). In FIG. 5, the process of Step S140 is indicated by “molding die closed?”

When the control section 71 determines that the movable molding die 13 is engaged with the fixed molding die 12 (YES in Step S140), the control section 71 controls the cleaning device 40 to cause the cleaning device 40 to start blowing air (Step S150). At this time, the control section 71 also causes the cleaning device 40 to start suction of air.

Next, the control section 71 controls the arrangement mechanism 30 to start moving the arrangement mechanism 30 back and forth along the path including the cleaning region (Step S160). The route may be the route itself connecting the first delivery position and the second delivery position, or may be another route included in the route connecting the first delivery position and the second delivery position as long as the route includes the cleaning region.

Next, the control section 71 continues reciprocating movement of the arrangement mechanism 30 that was started in Step S160 until the cleaning end condition is satisfied (Step S170). Here, the cleaning end condition may be, for example, instead of the completion of the hold pressure against the molded article in the space between the fixed molding die 12 and the movable molding die 13, that the number of times the arrangement mechanism 30 has passed through the cleaning region exceeds a predetermined number of times. In this case, however, the number of passes is a number of times determined in advance as the number of times that reciprocating movement of the arrangement mechanism 30 is completed within the period from the time when the movable molding die 13 is engaged with the fixed molding die 12 in Step S140 to the time when the movable molding die 13 is separated from the fixed molding die 12.

When the control section 71 determines that the cleaning end condition is satisfied (YES in Step S170), the control section 71 controls the cleaning device 40 and causes the cleaning device 40 to end the blowing of air (Step S180).

Next, the control section 71 controls the arrangement mechanism 30 and causes the arrangement mechanism 30 to move to the second delivery position (Step S190). In FIG. 5, the processing of Step S190 is indicated by “move to second delivery position”.

Next, the control section 71 controls the second robot 50 and causes the second robot 50 to palletize, onto the pallet PT, the plurality of molded articles that are placed on the arrangement mechanism 30 located at the second delivery position (Step S200).

Next, the control section 71 controls the arrangement mechanism 30 and causes the arrangement mechanism 30 to move to the first delivery position (Step S210). In FIG. 5, the processing of Step S210 is indicated by “move to first delivery position”.

Next, the control section 71 judges whether or not the molding of plural molded articles has been completed a predetermined number of times (Step S220). For example, in Step S220, if the injection molding section 11 has not newly molded a plurality of molded articles, the control section 71 determines that the predetermined number of times of molding plural molded articles has been completed. On the other hand, for example, in Step S220, when the injection molding section 11 is newly molding plural molded articles, the control section 71 determines that the predetermined number of times of molding plural molded articles has not been completed. The control section 71 may be configured to perform the determination of Step S220 by another method.

When the control section 71 determines that molding of the plurality of molded articles has not been completed (NO in Step S220), the control section returns to Step S110, and again waits until the movable molding die 13 is separated from the fixed molding die 12. Note that when in this standby state the injection molding section 11 completes the molding of a new plurality of molded articles, the control section 71 controls the first movement section 14 to separate the fixed molding die 12 and the movable molding die 13 from each other. By this, in Step S110 after returning, the control section 71 determines that the movable molding die 13 is separated from the fixed molding die 12.

On the other hand, when the control section 71 judges that molding of the plurality of molded articles has been completed (YES in Step S220), the control section 71 ends the processes of the flowchart shown in FIG. 5.

As described above, the control device 70 does not cause the cleaning device 40 to blow out air when the fixed molding die 12 and the movable molding die 13 are not engaged together, but causes the cleaning device 40 to blow out air when the fixed molding die 12 and the movable molding die 13 are engaged together. By this, the control device 70 can suppress that foreign matter enters between the fixed molding die 12 and the movable molding die 13 due to air being blown out from the cleaning device 40, and can prevent a decrease in molding accuracy of the molded article due to the adhesion of the foreign matter.

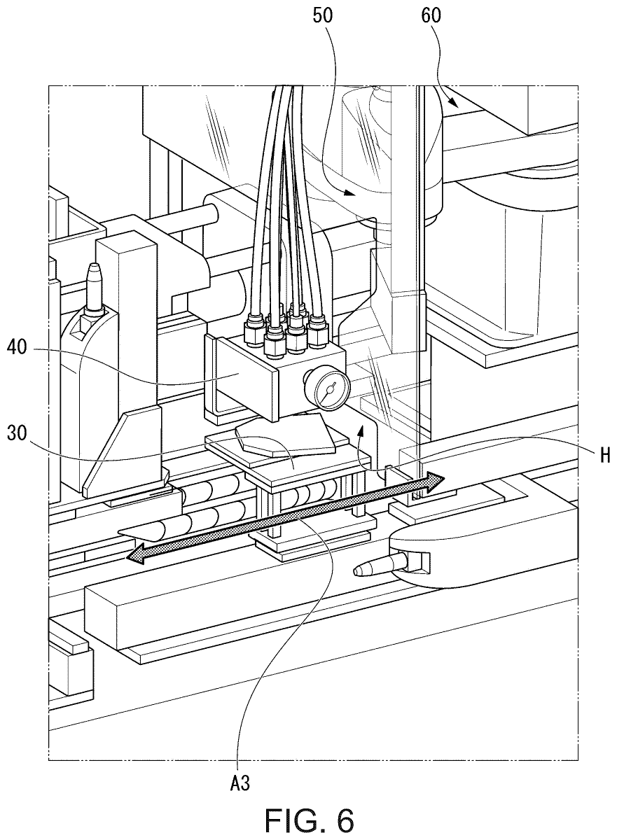

In the injection molding system 1 described above, when the injection molding system 1 is viewed in the negative direction of the X axis, the injection molding device 10, the cleaning device 40, and the pallet PT are arranged in the positive direction of the Y axis in the order of the injection molding device 10, the cleaning device 40, and the pallet PT. For this reason, in the injection molding system 1, a foreign substance such as dust generated on the frame BS may fall down onto the pallet PT in the sintering device 60 during the period before a plurality of molded articles are delivered from the arrangement mechanism 30 to the second robot 50. This is not desirable because there is a possibility that foreign matter will adhere to the plurality of molded articles after having been cleaned by the cleaning device 40. Therefore, in the injection molding system 1, as shown in FIG. 6, a partition plate BD may be provided between the cleaning device 40 and the pallet PT.

FIG. 6 is a perspective view showing an example of the periphery of the cleaning device 40 in the case where a partition plate BD is provided between the cleaning device 40 and the pallet PT. In the example shown in FIG. 6, the partition plate BD is provided between the cleaning device 40 and the sintering device 60. An opening H for allowing the arrangement mechanism 30 to enter the sintering device 60 is formed in the partition plate BD.

In the example shown in FIG. 6, the arrangement mechanism 30 is passing through a cleaning region located below the cleaning device 40. Through the process of Step S160 shown in FIG. 5, the arrangement mechanism 30 reciprocates along the direction indicated by the arrow A6 shown in FIG. 6. xxxBy this, the plurality of molded articles placed on the arrangement mechanism 30 are exposed to the air blown out from the cleaning device 40 each time the arrangement mechanism 30 passes through the cleaning region. As a result, foreign matter adhering to the plurality of molded articles is blown off by the air and sucked up by the cleaning device 40. However, some of the foreign matter blown off by the air may fly toward the inside of the sintering device 60 without being sucked up by the cleaning device 40. The partition plate BD can suppress foreign matter that flies toward the inside of the sintering device 60 from entering the sintering device 60.

The partition plate BD may be provided with a shutter for opening and closing the opening H, a door for opening and closing the opening H, and the like. In this case, the shutter, the door, and the like are controlled by the control device 70. The partition plate BD may be movable up and down in parallel with the Z axis, for example. In this case, the control device 70 can move the partition plate BD up or down in accordance with the movement of the arrangement mechanism 30 so that the partition plate BD does not obstruct movement of the arrangement mechanism 30.

The injection molding device 10, the cleaning device 40, and the pallet PT may be arranged in a direction not parallel to the Y axis in a view of the injection molding system 1 in the negative direction of the X axis.

The contents described above may be combined in any manner.

### Notes

(1)

An injection molding system including an injection molding device including an injection molding section that has a fixed section to which a fixed molding die and a movable molding die, which faces the fixed molding die and which is reciprocable with respect to the fixed molding die, are attached and fixed, and that is configured to mold a molded article by injecting a material containing a metal powder into a cavity formed between the fixed molding die and the movable molding die, and a first movement section for moving the movable molding die between a molding die closed position and a molding die open position; a cleaning device configured to clean a molded article that was taken out from the injection molding device by blowing air onto the molded article; and a control device configured to control the injection molding device and the cleaning device, wherein the control device, when the fixed molding die and the movable molding die are attached to the fixed section and the movable molding die is not located at the molding die closed position, does not cause the cleaning device to blow out air and, when the fixed molding die and the movable molding die are attached to the fixed section and the movable molding die is located at the molding die closed position, causes the cleaning device to blow out air.

(2)

The injection molding system according to (1), wherein the cleaning device blows ultrasonic vibration air as the air at the molded article.

(3)

The injection molding system of (1) or (2), wherein the injection molding device, the cleaning device, and a pallet on which the molded article cleaned by the cleaning device is placed are arranged in a predetermined first direction in the order of the injection molding device, the cleaning device, and the pallet and a partition plate is provided between the cleaning device and the pallet.

(4)

The injection molding system according to any one of (1) to (3), further including a second movement section for moving a relative position between the cleaning device and the molded article removed from the injection molding device and when the fixed molding die and the movable molding die are attached to the fixed section and the movable molding die is located at the molding die closed position, the control device controls the cleaning device and the second movement section and performs blowing of air at the molded article.

(5)

The injection molding system according to (4), wherein when the fixed molding die and the movable molding die are attached to the fixed section and the movable molding die is located at the molding die closed position, the control device controls the cleaning device and the second movement section to repeatedly perform blowing of air at the molded article and, after the blowing of the air at the molded article is completed, controls the first movement section and causes the movable molding die to move to the molding die open position.

(6)

The injection molding system according to any one of (1) to (5), wherein the injection molding section molds a plurality of molded articles, the injection molding system includes an arrangement mechanism on which a plurality of molded articles that were removed from the injection molding device are placed and which changes arrangement of the placed plurality of molded articles, and the control device controls the cleaning device and performs cleaning of the plurality of molded articles by causing air to blow at the plurality of molded articles placed on the arrangement mechanism.

(7)

The injection molding system according to (6), further including a robot for placing the plurality of molded articles that were cleaned by the cleaning device from the arrangement mechanism onto a pallet and the control device controls the robot to change intervals between the molded articles after the arrangement was changed by the arrangement mechanism, and to place the molded articles on the pallet after the intervals between the molded articles were changed.

(8)

The injection molding system according to any one of (1) to (5), wherein the injection molding section molds a plurality of molded articles in one injection step, the injection molding system includes an arrangement mechanism on which a plurality of molded articles that were removed from the injection molding device are placed and a robot for placing the plurality of molded articles from the arrangement mechanism onto a pallet, the control device controls the cleaning device and performs cleaning of the plurality of molded articles by causing air to blow at the plurality of molded articles placed on the arrangement mechanism, and the control device controls the robot to change the arrangement of the plurality of molded articles after cleaning was performed by the cleaning device, and to place the plurality of molded articles after the arrangement of the plurality of molded articles was changed onto the pallet.

(9)

The injection molding system according to any one of (1) to (5), wherein the injection molding system includes an arrangement mechanism on which the molded article taken out from the injection molding device is placed, a second movement section configured to move a relative position between the arrangement mechanism and the cleaning device, and a robot for placing the molded article from the arrangement mechanism onto a pallet, wherein the control device performs cleaning of the molded article by air by moving a relative position between the cleaning device and the arrangement mechanism on which the molded article is placed and then uses the robot to place the molded article after cleaning onto the pallet.

Although the embodiment of the present disclosure has been described in detail with reference to the drawings, the specific configuration is not limited to the embodiment, and may be changed, replaced, deleted, etc., as long as it does not depart from the gist of the present disclosure.

A program for realizing the function of any component in the device described above may be recorded on a computer-readable recording medium, and the program may be read and executed by a computer system. Here, the device is, for example, the control device 70. The term “computer system” as used herein includes hardware such as an operating system (OS) and peripheral devices. The term “computer-readable recording medium” refers to a portable medium such as a flexible disk, a magneto-optical disk, a ROM, or a compact disk (CD)-ROM, or a storage device such as a hard disk incorporated in a computer system. The term “computer-readable recording medium” also includes a storage medium that holds a program for a certain period of time, such as a volatile memory in a computer system that serves as a server or client when the program is transmitted via a network such as the Internet or a communication line such as a telephone line.

The program may be transmitted from a computer system in which the program is stored in a storage device or the like to another computer system through a transmission medium or by a transmission wave in the transmission medium. Here, “transmission medium” for transmitting a program refers to a medium having a function of transmitting information, such as a network such as the Internet or a communication line such as a telephone line.

The above-described program may be a program for realizing a part of the above-described functions. Further, the above-mentioned program may be a so-called difference file or a difference program, which can realize the above-mentioned functions in combination with a program already recorded in the computer system.

What is claimed is:

1. An injection molding system comprising:
an injection molding device including an injection molding section that has a fixed section to which a fixed molding die and a movable molding die, which faces the fixed molding die and which is reciprocable with respect to the fixed molding die, are attached and fixed, and that is configured to mold a molded article by injecting a material containing a metal powder into a cavity formed between the fixed molding die and the movable molding die, and a first movement section for moving the movable molding die between a molding die closed position and a molding die open position;
a cleaning device configured to clean a molded article that was taken out from the injection molding device by blowing air onto the molded article; and
a control device configured to control the injection molding device and the cleaning device, wherein
the control device,
when the fixed molding die and the movable molding die are attached to the fixed section and the movable molding die is not located at the molding die closed position, does not cause the cleaning device to blow out air and, when the fixed molding die and the movable molding die are attached to the fixed section and the movable molding die is located at the molding die closed position, causes the cleaning device to blow out air.

2. The injection molding system according to claim 1, wherein
the cleaning device blows ultrasonic vibration air as the air at the molded article.

3. The injection molding system according to claim 1, wherein
the injection molding device, the cleaning device, and a pallet on which the molded article cleaned by the cleaning device is placed are arranged in a predetermined first direction in the order of the injection molding device, the cleaning device, and the pallet and
a partition plate is provided between the cleaning device and the pallet.

4. The injection molding system according to claim 1, further comprising:
a second movement section for moving a relative position between the cleaning device and the molded article removed from the injection molding device and
when the fixed molding die and the movable molding die are attached to the fixed section and the movable molding die is located at the molding die closed position, the control device controls the cleaning device and the second movement section and performs blowing of air at the molded article.

5. The injection molding system according to claim 4, wherein
when the fixed molding die and the movable molding die are attached to the fixed section and the movable molding die is located at the molding die closed position, the control device controls the cleaning device and the second movement section to repeatedly perform blowing of air at the molded article and, after the blowing of the air at the molded article is completed, controls the first movement section and causes the movable molding die to move to the molding die open position.

6. The injection molding system according to claim 1, wherein
the injection molding section molds a plurality of molded articles,
the injection molding system includes an arrangement mechanism on which a plurality of molded articles that were removed from the injection molding device are placed and which changes arrangement of the placed plurality of molded articles, and
the control device controls the cleaning device and performs cleaning of the plurality of molded articles by causing air to blow at the plurality of molded articles placed on the arrangement mechanism.

7. The injection molding system according to claim 6, further comprising:
a robot for placing the plurality of molded articles that were cleaned by the cleaning device from the arrangement mechanism onto a pallet and
the control device controls the robot to change intervals between the molded articles after the arrangement was changed by the arrangement mechanism, and to place the molded articles on the pallet after the intervals between the molded articles were changed.

8. The injection molding system according to claim 1, wherein
the injection molding section molds a plurality of molded articles in one injection step,
the injection molding system includes
an arrangement mechanism on which a plurality of molded articles that were removed from the injection molding device are placed and
a robot for placing the plurality of molded articles from the arrangement mechanism onto a pallet,
the control device controls the cleaning device and performs cleaning of the plurality of molded articles by causing air to blow at the plurality of molded articles placed on the arrangement mechanism, and
the control device controls the robot to change the arrangement of the plurality of molded articles after cleaning was performed by the cleaning device, and to place the plurality of molded articles after the arrangement of the plurality of molded articles was changed onto the pallet.

9. The injection molding system according to claim 1, wherein
the injection molding system includes
an arrangement mechanism on which the molded article taken out from the injection molding device is placed,
a second movement section configured to move a relative position between the arrangement mechanism and the cleaning device, and
a robot for placing the molded article from the arrangement mechanism onto a pallet and
the control device performs cleaning of the molded article by air by moving a relative position between the cleaning device and the arrangement mechanism on which the molded article is placed and then uses the robot to place the molded article after cleaning onto the pallet.
